(19) United States
(12) Patent Application Publication
(10) Pub. No.: US 2017/0160077 A1
(43) Pub. Date: Jun. 8, 2017

(54) METHOD OF INSPECTING AN OBJECT WITH A VISION PROBE

(71) Applicant: RENISHAW PLC, Wotton-under-Edge, Gloucestershire (GB)

(72) Inventors: Timothy C FEATHERSTONE, Edinburgh (GB); Martin S REES, Thornbury (GB)

(73) Assignee: RENISHAW PLC, Wotton-under-Edge, Gloucestershire (GB)

(21) Appl. No.: 15/118,390

(22) PCT Filed: Feb. 23, 2015
(86) PCT No.: PCT/EP2015/053687

§ 371 Date: Aug. 11, 2016

(30) Foreign Application Priority Data
Feb. 24, 2014 (EP) 14275029.8

(51) Int. Cl. G01B 11/24; G01N 21/894; G01B 11/255

(52) U.S. Cl. CPC G01B 11/2433; G01B 11/255; G01N 21/894; G01N 2021/8829

(57) ABSTRACT

A method of inspecting a hole in an object with at least one camera probe mounted on a coordinate positioning machine includes: for a plurality of different viewpoints obtaining at least one image of a silhouette of the hole from a first end of the hole, so as to obtain a set of silhouette images of the hole, the hole being backlit so as to form the silhouette, and using the set of silhouette images of the hole to infer at least part of the boundary of the hole at a given height.

The present invention relates to a method of inspecting an object, in particular with a camera probe.

Camera probes are known for capturing images of an object to be inspected. The camera probe is moved about the object, e.g. by a movement apparatus, and collects images of the object. At some point (e.g. could be immediately after they are captured or at some time after collection) the images are processed to determine information about the object. This could be by a processor on the camera probe, or external to the camera probe.

In some situations it is desirable to use the camera probe to inspect select features on the object as the camera probe moves about the object. For example, it might be desirable to inspect one or more holes/bores/apertures in an object, e.g. to determine their size and/or form.

WO2009/141606 and WO2010/139950 disclose known techniques for measuring a hole using a camera probe. WO2009/141606 discloses illuminating an object using a laser beam which is projected through the camera lens system. The light spot is projected onto a part of an edge to be measured so as to put it into silhouette. The camera's field of view is such that it only sees a small section of the hole's edge (so only a partial silhouette of the hole is seen by the camera probe) and therefore the camera is driven around so as to follow the edge and obtain a series of images which are subsequently stitched together. In WO2010/139950 a measure of focus of a silhouette created by a through the lens illuminated spot projected onto the edge is used to find an edge of a particular part of a hole and to help the camera probe follow the edge of the hole. In WO2009/141606 and WO2010/139950, the camera's depth of field is sufficiently shallow such that the height of the in-focus region is known, and such that the actual position of the edge can be directly measured. In other words, with the techniques of these documents, it is analogous to bringing the stylus tip of a contact probe into touch the edge of interest so as to directly measure it.

The present invention relates to an alternative technique for obtaining metrological information about an object, in particular about a hole in an object. The present invention provides a technique which comprises obtaining at least one image of the silhouette of the hole from a viewpoint and processing that at least one image in order to infer metrological information about the hole. For example, the present invention provides a technique which comprises obtaining a plurality of images of the silhouette of the hole from different viewpoints and processing those images in order to obtain metrological information about the hole.

According to a first aspect of the invention there is provided a method of inspecting a hole in a workpiece with a camera probe mounted on a coordinate positioning machine, comprising: for at least one (e.g. a plurality of different) view point(s) obtaining at least one image of a silhouette of the hole from a first end of the hole, (e.g. so as to obtain a set of silhouette images of the hole,) and using said (e.g. set of) silhouette image(s) of the hole to infer at least part of the boundary of the hole, e.g. the position of at least one point (e.g. a plurality of points) on the hole's surface.

Using a (e.g. set of) silhouette image(s) to infer hole profile information enables a hole/bore/aperture (references in this document to “hole” are interchangeable with “aperture” and “bore”) to be inspected quickly and reliably. As the image(s) is/are obtained from a first end of the hole, this means that the hole can be inspected from one side only, even parts of the hole distal to its opening at the first end. Although the hole's boundary information is inferred as opposed to directly measured (like in WO2009/141606 and WO2010/139950) it has been found that the positions on the surface of the hole can still be inferred with sufficient accuracy, and is particularly appropriate for inspecting certain aspects of the hole, such as for example the minimum cross-sectional area of a hole.

As will be apparent from this description, the method of the invention can be used to infer just one discrete point on the surface of the hole, e.g. on its inner surface. Optionally, the method of the invention can be used to infer a plurality of discrete points on the (e.g. inner) surface of the hole. Optionally, the plurality of points can extend around the circumference of the (e.g. inner) surface of the hole, and for example can all be contained within a notional measurement surface (e.g. a plane). Optionally, the method of the invention can be used to infer a three-dimensional model of the hole, along at least part of its length, and optionally along its entire length.

The silhouettes obtained using the camera probe according to the invention can be created by different (e.g. unknown) parts of the hole at different (e.g. unknown) heights/depths. That is, the silhouette of at least one image can be created by different parts of the hole at different heights/depths. Accordingly, the method can comprise, using at least one image to infer at least one point on the surface of the hole at at least two different heights within the hole. For example, the method can comprise, from at least one image, inferring the position of at least one point proximal a first end of the hole. Optionally, the method comprises, from at least one image, inferring the position of at least one point distal the first end of the hole. For example, the method can comprise inferring point(s) at the end of the hole distal to the first end of the hole (e.g. inferring point(s) at the bottom of the hole). For example, the method can comprise, from at least one image, inferring the position of at least one point proximal a first end of the hole and the position of at least one point distal the first end of the hole (e.g. inferring point(s) at the top and bottom of the hole).

The method of the invention can comprise distilling from said silhouette images hole position information (e.g. point information, e.g. profile information) at at least one height/depth, e.g. at at least two heights/depths. Accordingly, the method of the invention can comprise processing an image of the silhouette to identify at least part of the boundary of said hole at at least two different heights/depths. Accordingly, the method can comprise selecting one or more heights with respect to the hole to be inspected and using said set of silhouette images to infer at least part of the boundary of the hole at said one or more heights.

As will be understood, the viewpoint(s) can be a known viewpoint(s). For example, at least a relative position and/or orientation of the viewpoint can be known. For instance, for a set of images, the relative positions/orientations of the viewpoints can be known. Optionally, the relative position/orientation of the viewpoint with respect to the object can be known. Optionally, the absolute position/orientation of the viewpoint within the coordinate positioning apparatus's measurement volume is known.

Such viewpoints can be known from data from the coordinate positioning machine on which it is mounted. For example, the viewpoint(s)/camera perspective centre(s) can be known from knowledge of the position (and e.g. orientation) of the coordinate positioning machine, e.g. from reading the outputs of the coordinate positioning machine's position sensors.

Inferring can comprise assuming for a given (e.g. known/predetermined) height/depth (of the hole) that the edge of the silhouette is created by the boundary of the hole (e.g. the hole's wall/inner surface) at that height/depth. As will be understood, said height/depth can be a given/known/predetermined height/depth (e.g. in a first dimension) (e.g. a Z dimension) within the coordinate positioning machine's measurement volume. Likewise, said determining the position of at least part of the boundary can be determining the lateral position/location (e.g. in second and third mutually perpendicular dimensions) (e.g. X and Y dimensions) of at least part of the boundary of the hole within the coordinate positioning machine's measurement volume for said given/known/predetermined height/depth.

Accordingly, the method can comprise using said silhouette image(s) of the hole to infer the position of at least part of the boundary of the hole (e.g. at least one point on the boundary of the hole) at a given height/depth. As explained in more detail below, the method can also comprise, for a plurality of different given/known/predetermined heights/depths, using said silhouette image(s) of the hole to infer the position of at least part of the boundary of the hole (e.g. the position of at least one point on the boundary of the hole).

Using said (set of) silhouette image(s) can comprise identifying an edge in said silhouette. Optionally, using said (set of) silhouette image(s) can comprise using an edge detection process on an image to identify in the image at least one point on an edge of the silhouette in said image. Optionally, the method can comprise using an edge detection process to identify within one image at least a first point on the boundary of the hole at a first height/depth (e.g. a first end/top of the hole) of said hole and at least a second point on the boundary of the hole at a second height/depth (e.g. a second end/bottom of the hole) of said hole.

Optionally, the method comprises inferring which part of the silhouette in an image relates to a part of the hole at a first height/depth (e.g. a first end/top of the hole) and which part of the silhouette relates to a part of the hole at a second height/depth (e.g. a second end/bottom of the hole).

As will be understood, said at least one height/depth can be arbitrary with respect to the camera probe. That is the at least one height/depth at which at least a part of the hole's boundary is inferred (e.g. at which the lateral position of one or more points on the hole's surface is inferred) can be selected independent of the camera probe (e.g. of the camera probe's optics, e.g. arbitrary and independent of the camera probe's object focal plane). As will be understood, arbitrary in this sense does not necessarily mean random, but rather can mean that the height/depth can be selected subject to individual choice, e.g. without restriction. Accordingly, the feature(s) of interest/to be inspected need not necessarily be located at or near the camera probe's object focal plane when the image(s) is(are) obtained.

Optionally, the method can comprise inferring at least part of the boundary of the hole (e.g. inferring said at least one point) which does not lie on the camera's object focal plane of any of the plurality of images. In other words, the method can comprise inferring at least part of the boundary of the hole that is off the camera's object focal plane. Accordingly, the method can comprise, for at least one height/depth that does not lie on the camera's object focal plane at the point at which the images were obtained, using said set of silhouette images to infer at least part of the hole's boundary (e.g. infer the position/location of at least one point (e.g. a plurality of points) on the hole's inner surface/wall) at said height/depth. Accordingly, rather than being restricted to inspecting the hole only at those points that lie on the camera probe's object focal plane at the point the images were obtained, the method can be used to infer at least part of the hole's boundary (e.g. the location of one or more points on the hole's inner surface/wall) that lie outside the camera's object focal plane.

The method can comprise for a plurality of different viewpoints (e.g. for a plurality of different positional relationships) obtaining at least one image of the entire (or “complete”) silhouette of the hole from a first end of the hole. Accordingly, the camera probe's field of view can be arranged so as to contain the entire first end of the hole.

The method can comprise for a plurality of different viewpoints (e.g for a plurality of different positional relationships) obtaining at least one image of the silhouette of a plurality of holes in the workpiece from a first end of the holes. This can enable a plurality of holes to be inspected using the same image(s).

Accordingly, the method can comprise using said set of silhouette images of said plurality of holes to infer the position of at least a part of the boundary of a plurality of holes (e.g at least one point on the (e.g. inner) surface/wall of a plurality of holes). Optionally, the inferred at least part of the boundary of said holes are at the same height/depth (e.g. the points are all at the same height/depth). For example, optionally, the method can comprise, for at least one given/known height, using said set of silhouette images of said plurality of holes to infer at least part of the hole's boundary for each hole (e.g. the position/location of at least one point on each of the hole's surfaces), at said height.

The above mentioned given (e.g. known) height/depth can comprise a given (e.g. known) notional measurement surface. Accordingly, said inferred (e.g. plurality of) point(s) could be contained within said notional measurement surface. For example, the method can comprise, using said set of silhouette images of said hole (or plurality of holes) to infer at least part of the hole (or hole's) boundary at a notional measurement surface that intersects the hole (or holes).

An example of such a notional surface is a plane. However, as will be understood, the notional surface need not necessarily be flat, but instead could be non-linear (e.g. curved) in one or more dimensions. For example, the notional surface could be cylindrical, spherical or for example conical. In some circumstances it can be useful for the notional surface to have a shape that corresponds to the general shape of the object in which the hole is located (e.g. for a flat planar object, the notional surface could be planar, whereas for a cylindrical object the notional surface might be cylindrical too). Other appropriate terms for said notional surface include notional measurement surface, virtual surface, and abstract geometrical construct. Said notional surface can cross the hole's longitudinal axis. For example, said notional surface can be approximately perpendicular to the hole's longitudinal axis (i.e. at least at its point of intersection with the hole's longitudinal axis).

Said notional surface can be located part way down the hole. Optionally, said notional surface is proximal, or at, the end of the hole distal the first end.

The hole can be a through hole. That is the hole can have at least two open ends. Optionally the object is substantially sheet like. Optionally, the object is a blade, e.g. a turbine blade. The object can be substantially planar. The object can be non-planar, e.g. curved or undulating. For example, the object can be generally cylindrical in shape. For instance, the object can be a generally ring-shaped object, with at least one hole extending though the wall of the ring.

The method can comprise using said set of silhouette images of the hole to infer the position of at least one point, preferably a plurality of points, on the hole's surface for each of at least two different heights/depths (e.g. for at least two different notional surfaces). Optionally, the position of points on the hole's surface for at least two different heights/depths (e.g. two different notional surfaces) is inferred from the same image.

The method (e.g. said inferring) can comprise using knowledge about the location of one or more features of the object. For example, the method can comprise using knowledge about the location of the object's surface that contains the top of the hole and/or knowledge about the location of the object's surface that contains the bottom of the hole. Such knowledge can be determined from directly measuring such feature (e.g. the surface of the object defining the top opening of the hole). Such knowledge can be determined from directly measuring a different feature of the object and/or another object to which the object is fixed (e.g. a fixturing). For example, the location of the object's surface containing the bottom of the hole can be known by directly measuring the surface defining the top of the hole and from knowledge of the thickness of the object.

Accordingly, the method can comprise measuring the location of the height/depth of the hole at which the hole's boundary is to be inferred (e.g. measuring the location of the notional surface). For example, the notional surface can contain the first end of the hole. The method can comprise measuring the location of the face containing the first end of the hole. The location of the notional surface can be measured directly using a measurement probe, e.g. a contact or non-contact probe. Optionally, the measurement probe is a different probe to the camera probe.

The camera can comprise one or more lenses for forming an image on an image sensor. Preferably, the camera probe is non-telecentric, i.e. it has perspective distortion. Although it can help to have a camera with a large depth of field such that all of the hole is in focus, this need not necessarily be the case. As will be understood, some (or even all) parts of the hole can be out of focus to a certain extent (e.g. to the limits of the image analysis techniques/software) and image analysis software can be used to identify the edge of the silhouette captured by the camera.

The method can comprise one camera probe obtaining a plurality (or all) of the images in said set of the silhouette images. In this case, the different viewpoints can be achieved by moving the camera probe between obtaining images. Optionally, however, the camera can, for example, have a plurality of centre of perspectives. For example, the camera probe could comprise a light-field camera (also known as a plenoptic camera). In another example, the camera probe could comprise multiple optic systems for forming multiple images onto different sensors (or optionally selectively onto one sensor), i.e. the camera probe can essentially comprise a plurality of separate cameras. Optionally, the camera probe could comprise an internally moveable centre of perspective to provide a change in viewpoint. Accordingly, the different viewpoints can be achieved without physically moving the camera probe with respect to the hole, e.g. by obtaining the images using the camera's different perspective centres, or by moving the camera's perspective centre (e.g. by shifting the optics within the camera).

Accordingly, the method can comprise for at least one (e.g. known) camera perspective centre, obtaining at least one image of a silhouette of the hole from a first end of the hole, so as to obtain a silhouette image of the hole, the hole being backlit so as to form said silhouette, and using said silhouette image of the hole to infer at least part of the boundary of the hole at a given height.

Optionally, a single camera probe is used to obtain all of the images in said set of silhouette images, and the method comprises relatively moving the camera probe and object so as to achieve said different viewpoints. Accordingly, the method can comprise for a plurality of different positional relationships between the camera probe and the object/hole, obtaining at least one image of a silhouette of the hole from a first end of the hole, so as to obtain a set of silhouette images of the hole.

Optionally, a plurality of separate camera probes are provided, each having a different view point of the hole/object. In this case, the method can comprise the different camera probes obtaining images of the hole's silhouette from different viewpoints.

As will be understood, there can be ambiguity in the data that any one silhouette image provides. For instance, any one point on the boundary of the imaged silhouette could have been created by the hole at number of different points in the coordinate positioning machine's measurement volume. Inferring can comprise reducing the extent of any such ambiguity or uncertainty (e.g. at least partially resolving). As mentioned this can be done by using knowledge about the location of one or more features of the object (in the coordinate positioning machine's measurement volume). Optionally, this can be done by using multiple silhouette images. E.g. the method could comprise using multiple silhouette images in order to infer a viable hole boundary or a viable hole volume.

As will be understood, the method of the invention can comprise using knowledge about the relative position (and e.g. orientation) of the object and the camera probe (e.g. at the point an image was obtained). For example, the method can comprise determining the relative position (and e.g. orientation) of the object and camera probe at the point an image was obtained. For example, this can comprise reading the outputs of position sensors (e.g. encoders) on the coordinate positioning machine.

Different viewpoints can mean that the images can be obtained at different positional heights with respect to the hole and/or different transverse positions with respect to the hole and/or different angular orientations with respect to the hole. As will be understood, the centre of perspective of the camera for the different images can be at different positions with respect to the hole. (In the case of a telecentric camera probe, the centre of perspective can be considered to have a centre of position with a specific x, y dimensional value but which is located at infinity in the z dimension (in which case a different perspective centre for a telecentric camera can involve a change in relative position between the camera probe and hole in the x and y dimensions)).

Accordingly, the camera probe and/or the object could be mounted such that it/they can move relative to the other in at least one linear degree of freedom, optionally at least two orthogonal linear degrees of freedom, for instance three orthogonal degrees of freedom. Optionally, the camera probe and/or the object could be mounted such that it/they can move relative to the other about at least one rotational axis, optionally about at least two (e.g. orthogonal) rotational axes, for instance about at least three (e.g. orthogonal) rotational axes.

The coordinate positioning machine could be a Cartesian or non-Cartesian coordinate positioning machine. The coordinate positioning machine could be a machine tool, coordinate measuring machine (CMM), articulated arm or the like. Optionally, the camera probe is mounted on an articulated head that provides at least one rotational degree of freedom, optionally at least two orthogonal degrees of freedom. The articulated head could be an indexing head (that has a finite number of indexable orientations) or a continuous head. The camera probe could be mounted on the quill of a coordinate positioning machine that provides for movement of the quill (and hence the articulated head and/or camera probe mounted on it) in at least one, optionally at least two and for example at least three orthogonal linear dimensions. Optionally, the object to be inspected is mounted on a moveable table, for example a rotary table.

Optionally, the image(s) can be obtained with the camera and object relatively stationary. Optionally, the image(s) can be obtained with the camera and object moving relative to each other. When the camera probe is mounted on a continuous articulated head, the images could be obtained whilst the camera probe is being reoriented by the head.

The method can comprise generating from said (e.g. set of) image(s) at least one notional geometrical construct representing the hole, and using said at least one notional geometrical construct to infer at least part of the boundary of said hole. This can comprise generating for each of said plurality of images obtained from different view points at least one notional geometrical construct known to fit the hole. Said notional geometrical constructs can be used to infer at least part of the boundary of the hole. For example, the method can comprise combining said notional geometrical constructs determined for each view point to provide a resultant notional geometrical construct (which is then used to infer at least part of the boundary of said hole). For example, said notional geometrical construct can comprise a bundle of vectors representing light rays which can be deduced to have passed through said hole. Optionally, said notional geometrical construct can comprise at least one geometrical shape representing at least a part of the hole.

Inferring can comprise performing vector analysis of the light rays creating the silhouette to determine the boundary of the silhouette at a given (e.g. known) height/depth. Accordingly, inferring can comprise determining the vector of at least one light ray that passed through the hole so as to create the boundary of the silhouette, e.g. that grazed the boundary/edge of the hole. As will be understood, the vector/light ray can be a straight line from the backlight, through the hole, through the camera's perspective centre and onto the camera's sensor. For example, the method can comprise generating a plurality (e.g. a bundle) of vectors representing the light rays that passed through the hole so as to create the silhouette images as obtained from the different positional relationships. Accordingly, different vectors/light rays can be used to represent different points around the edge/boundary of the hole. That is different vectors/light rays can graze different points around the edge/boundary of the hole. The method can comprise analysing the (e.g. plurality of) vector(s) to infer metrological information concerning the hole, e.g. hole boundary information, e.g. cross-sectional profile information. For example, the method could comprise generating a three-dimensional model that fits within the boundary defined by said plurality of vectors. For example, the method can comprise for at least one notional surface (e.g. a plane) that intersects the bundle of vectors, identifying at least one point lying on the boundary defined by said vectors at said notional surface. The method can comprise, for a plurality of notional surfaces that intersect the bundle of vectors, identifying at least one point lying on the boundary defined by said vectors at each of said notional surfaces. Accordingly, for example, the cross-sectional shape and/or size of the hole at any particular notional surface can be inferred from the boundary defined by the bundle of vectors intersecting said notional surface. As will be understood, an inferred profile of the hole along its length can be generated by inferring the hole's cross-sectional shape/size at a plurality of different depths.

Optionally, the hole is backlit (i.e. from the end opposite to that which the images are obtained; in accordance with the above from the end distal to the first end). Accordingly, optionally, the hole appears as a bright spot on the camera's image sensor.

According to a second aspect of the invention there is provided an apparatus comprising: at least one camera probe mounted on a coordinate positioning apparatus for obtaining images of a workpiece comprising at least one hole to be inspected; a controller configured to control the camera probe such that for at least one (e.g. for a plurality of different) view point(s), at least one image of a silhouette of the hole from a first end of the hole is obtained, (e.g. so as to obtain a set of silhouette images of the hole), and a processor configured to use said (e.g. set of) silhouette image(s) of the hole to infer at least part of the boundary of the hole.

According to a third aspect of the invention there is provided a method of inspecting a plurality of holes with a camera probe mounted on a coordinate positioning machine, comprising: for a plurality of different positional relationships obtaining at least one image of the silhouette of the plurality of holes from a first end of the holes, and processing the silhouette images to determine metrological information concerning the plurality of holes. For example, the method can be used to determine hole profile information (e.g. cross-sectional profile information), such as the hole's form, shape, dimension, size, etc at least at one height/depth (e.g. for at least one notional surface through the hole).

According to another aspect of the invention there is provided a method of inspecting a hole in a workpiece with at least one camera probe mounted on a coordinate positioning machine, the method comprising, obtaining at least one image of a silhouette of the hole, and processing said image to identify at least part of the boundary of said hole at at least two different heights/depths. Accordingly, the method can comprise processing one image only so as to identify at least part of the boundary of said hole at at least two different heights/depths. For example, the method can comprise processing said image to identify at least part of the boundary (e.g. at least one point, e.g. a plurality of points) at or toward a first end of the hole and at least part of the boundary (e.g. at least one point, e.g. a plurality of points) at or toward a second end of the hole. For example, the method can comprise processing said image to identify at least part of the boundary (e.g. at least one point, e.g. a plurality of points) at the bottom edge of the hole and at least part of the boundary (e.g. at least one point, e.g. a plurality of points) at the top edge of the hole. This process can be repeated for different images, e.g. obtained from different viewpoints.

Accordingly, the method can comprise inferring which part of the silhouette in an image relates to a part of the hole at a first height/depth (e.g. a first end/top of the hole) and which part of the silhouette relates to a part of the hole at a second height/depth (e.g. a second end/bottom of the hole).

Said processing can comprise identifying an edge in said silhouette image. Accordingly, said processing can comprise using an edge detection method. The method can comprise inferring the position of at least one point of said identified edge within the coordinate positioning machine's measurement volume. Such inferring can be based on knowledge of the position of the camera probe at the point said at least one image was obtained. Such inferring can be based on knowledge of the location of at least a part of the object. For example, such inferring can be based on knowledge of the location of a surface of the object, e.g.

the surface containing the mouth of the hole. Accordingly, the method can comprise measuring the location of at least a part of the object, e.g. measuring the location of the surface containing the mouth of the hole.

As will be understood, features described above in connection with the other embodiments of the invention are applicable to this embodiment of the invention and vice versa. For example, as described above in connection with the other embodiments of the invention, the method can comprise obtaining at least one image of the silhouette of the hole from a plurality of different viewpoints. The method can therefore comprise processing a plurality of images to identify in each of said plurality of images at least part of the boundary of said hole at at least two different heights/depths.

Also, as described above in connection with the other embodiments of the invention, the method can be used to inspect a plurality of holes concurrently. Accordingly, the method can comprise obtaining at least one image of the silhouettes of a plurality of holes and processing said image so as to identify, for a plurality of said holes, at least part of the hole's boundary at at least two different heights/depths.

Embodiments of the invention will now be described, by way of example only, with reference to the following drawings in which:

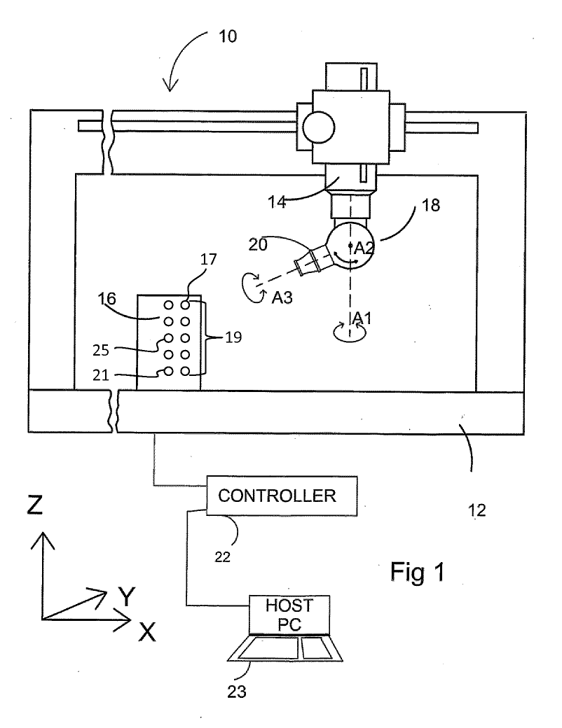

FIG. 1 illustrates of a camera probe mounted on an articulated head of a coordinate measuring machine (CMM) for measuring an object;

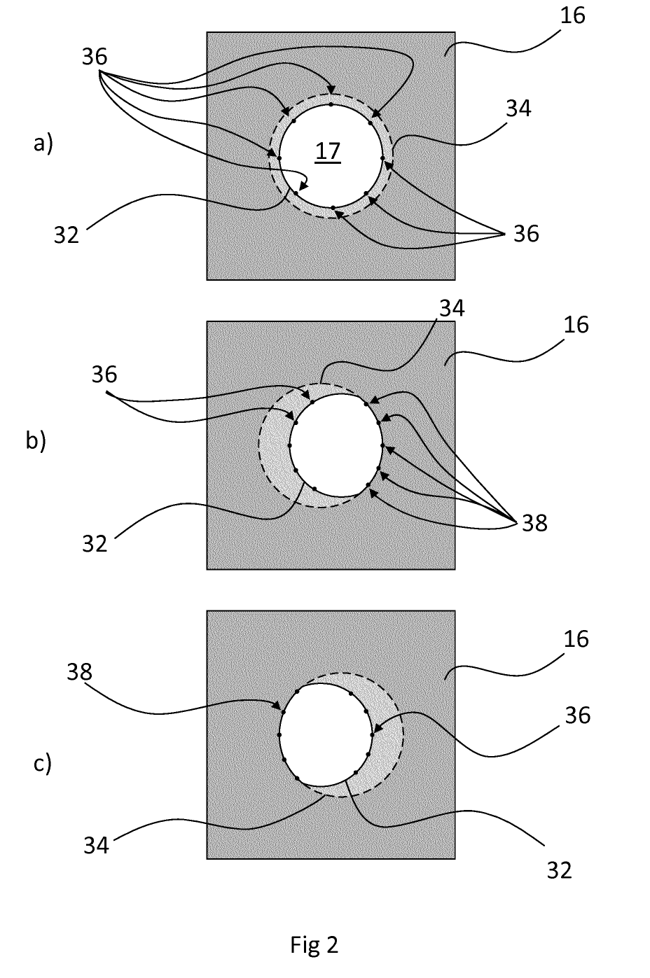

FIGS. 2a, 2b and 2c illustrate three different silhouette images obtained from three different positions;

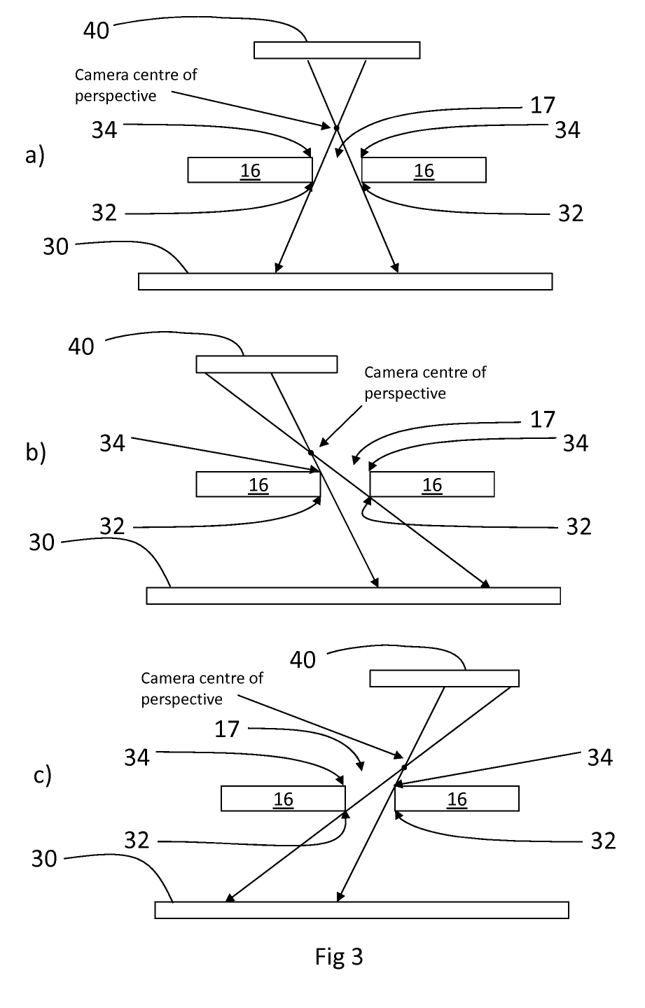

FIGS. 3a, 3b and 3c illustrate vector diagrams for the corresponding silhouette images in FIGS. 2a, 2b and 2c;

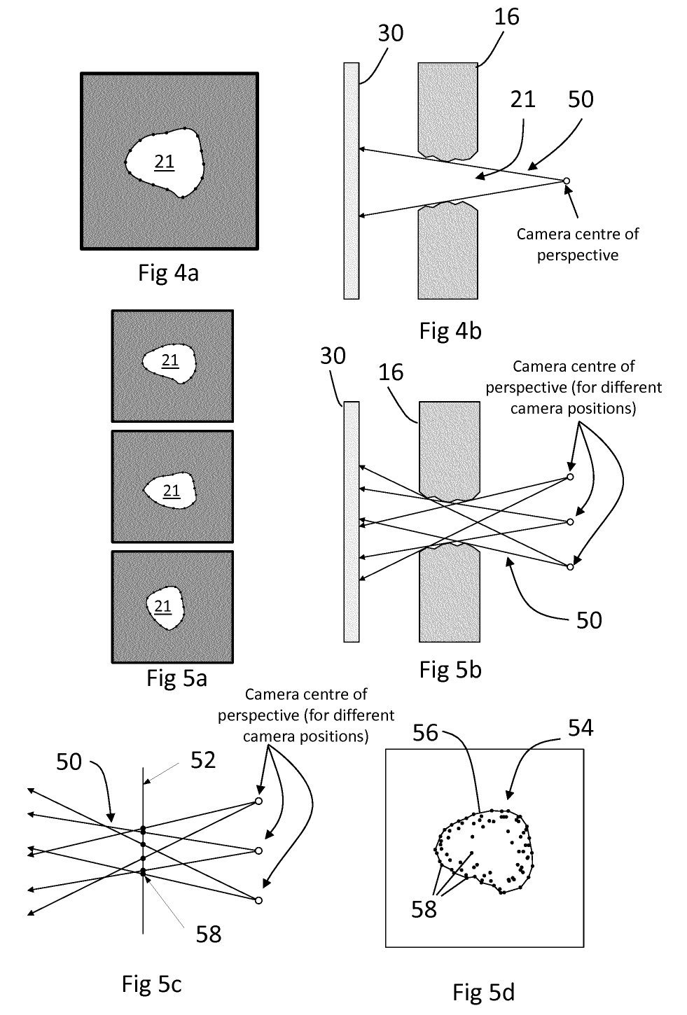

FIGS. 4a and 4b respectively illustrate the silhouette and a corresponding vector diagram for an irregular hole;

FIGS. 5a and 5b respectively illustrate various silhouette images obtained from different camera positions and a vector diagram for those different camera positions;

FIGS. 5c and 5d schematically illustrate identifying the hole boundary from a plurality of vectors for a given plane through the hole of FIGS. 5a and 5b;

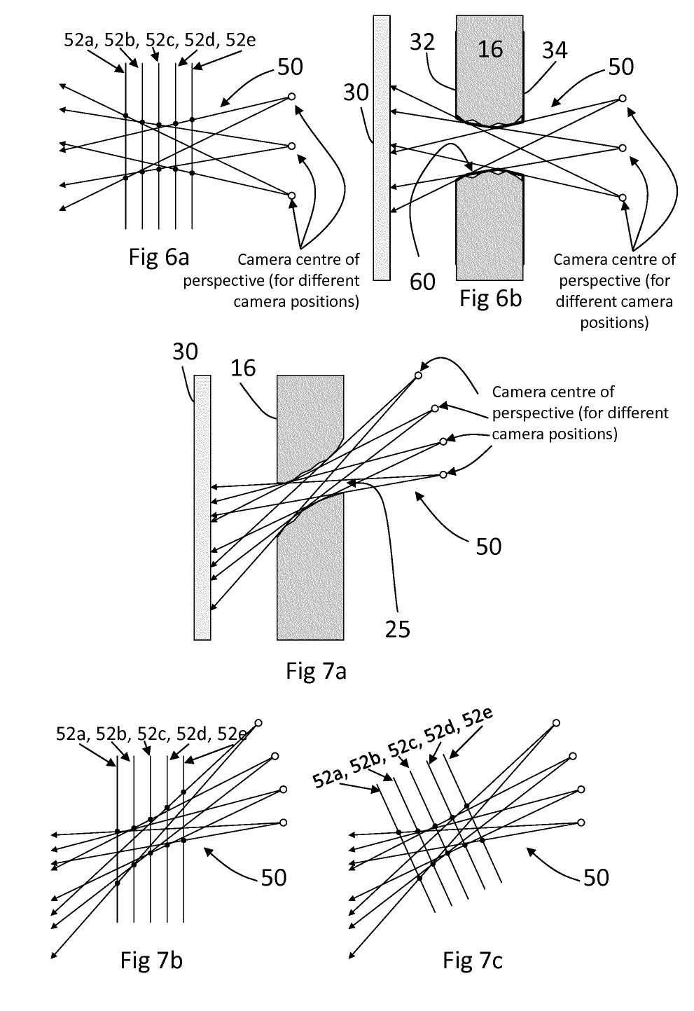

FIGS. 6a and 6b schematically illustrate identifying the hole boundary from a plurality of vectors for a plurality of different planes through the hole of FIGS. 5a and 5b;

FIGS. 7a, 7b and 7c schematically illustrate identifying the hole boundary from a plurality of vectors for a plurality of different planes through the hole;

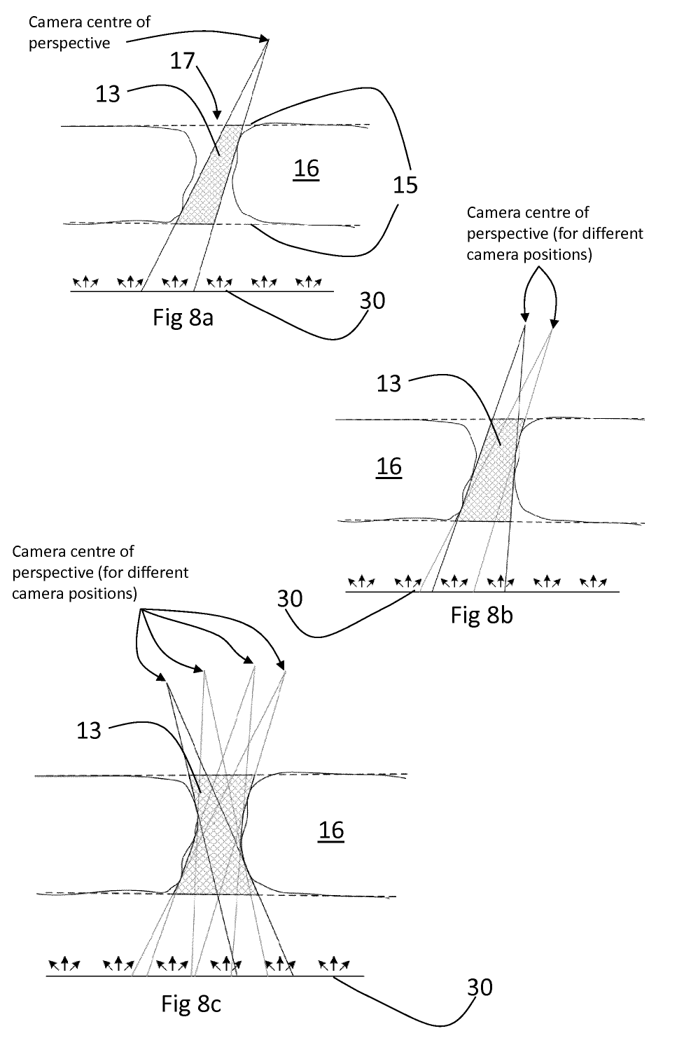

FIGS. 8a, 8b, and 8c schematically illustrate a further technique of inferring hole boundary information from silhouettes obtained from a number of different view points according to the invention; and

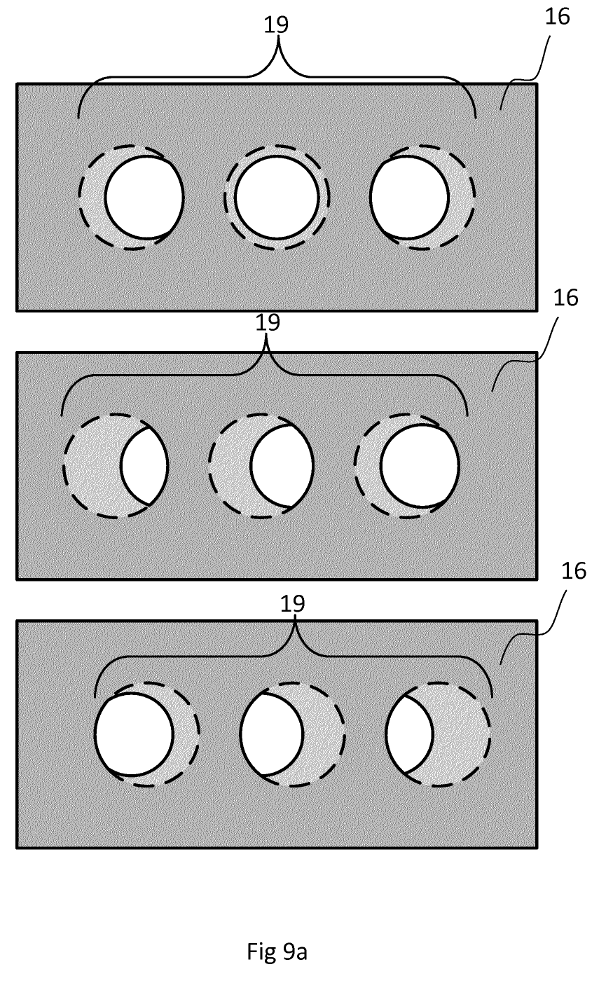

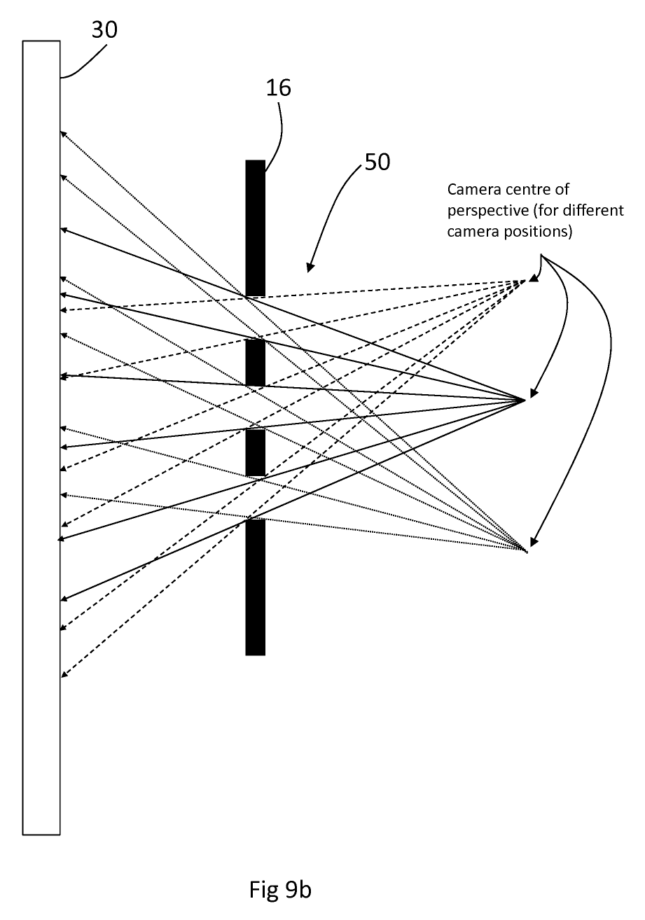

FIGS. 9a and 9b respectively illustrate a plurality of hole silhouettes being obtained in one image and vectors for a plurality of holes from a plurality of different camera positions.

FIG. 1 illustrates an object inspection apparatus according to the invention, comprising a coordinate measuring machine (CMM) 10, a camera probe 20, a controller 22 and a host computer 23. The CMM 10 comprises a table 12 onto which an object 16 can be mounted and a quill 14 which is movable relative to the table 12 in three orthogonal linear dimensions X,Y and Z. An articulated probe head 18 is mounted on the quill 14 and provides rotation about at least two orthogonal axes A1, A2. The camera probe 20 is mounted onto the articulated probe head 18 and is configured to obtain images of the object 16 located on the table 12. The camera probe 20 can thus be moved in X, Y and Z by the CMM 10 and can be rotated about the A1 and A2 axes by the articulated probe head 18. Additional motion may be provided by the CMM or articulated probe head, for example the articulated probe head may provide rotation about the longitudinal axis of the video probe A3. Optionally, the object 16 can be mounted on a rotary table to provide a rotational degree of freedom.

The desired trajectory/course of motion of the camera probe 20 relative to the object 16 is calculated by the host computer 23 and fed to the controller 22. Motors (not shown) are provided in the CMM 10 and articulated probe head 18 to drive the camera probe 20 to the desired position/orientation under the control of the controller 22 which sends drive signals to the CMM 10 and articulated probe head 18. The positions and orientations of the various axes of the CMM 10 and the articulated probe head 18 are determined by transducers, e.g. position encoders, (not shown) and the positions are fed back to the controller 22. As will be understood, the positions and orientation information can be used during the obtaining of metrological information about a feature of interest.

The camera probe 20 can be detachably mounted to the articulated probe head 18. Different (contact or non-contact) probes can be mounted on the articulated probe head 18 in place of the camera probe 20. For example, a contact probe comprising a deflectable stylus for contacting the object 16 can be mounted on the articulated probe head 18. The contact probe could be a touch-trigger probe which provides a signal on detection of deflection of the stylus caused by contact with the object 16 or an analogue (or scanning) probe which provides a measure of deflection of the stylus (in at least one, two or three dimensions) caused by contact with the object 16. The CMM 10 could comprise a rack for storing a plurality of different probes (e.g. contact and/or non-contact), located within the articulated head's 18 operation volume, such that probes can be automatically interchanged on the articulated head 18.

As illustrated in FIG. 1, the object 16 to be inspected comprises a plurality 19 (or a set 19) of holes 17. In this embodiment, the holes 17 are through-holes in that they pass all the way through the object 16.

Methods of inspecting a hole 17 in the object 16 according to the invention will be described with reference to the remaining drawings. A first method according to the invention is illustrated with respect to FIGS. 2 and 3. In this case, the hole 17 has a known form (in this case generally cylindrical) and the technique is used to confirm the shape and size of the ends of the hole. Starting with FIG. 2a, if the camera probe 20 is placed on the axis of the hole 17 (i.e. so that its imaging axis is coincident with the hole's axis), and the hole 17 is backlit using a light source 30 (not shown in FIG. 1), then the resulting camera image will show a silhouette of the hole 17 with a bright circle where the backlight shines through the hole, as shown in FIG. 2a. Because of the perspective distortion of the camera probe's lens, the front of the hole 17 appears larger on the image than the back of the hole, so (based on assumed knowledge that the hole 17 is generally cylindrical) all the measurement points 36 can be assumed to relate to the back edge 32 of the hole 17.

If the position of the camera probe 20 is moved away from the axis of the hole 17, for example if the camera probe 20 is translationally moved in a first direction perpendicular to the hole's longitudinal axis, then a different image is formed, as shown in FIG. 2b. Based on assumed knowledge that the hole 17 is generally cylindrical, image analysis can be used to attribute one half of the bright silhouette to the front 34 of the hole 17, and the other half to the back 32 of the hole 17. This allows one set of measurement points 38 to be created for the front edge 34 of the hole 17, as well as adding to the set of measurement points 36 for the back edge 32 of the hole 17.

The position of the camera probe 20 is then moved away from the axis of the hole 17 in a different direction, for example if the camera probe 20 is translationally moved in a second direction that is directly equal and opposite to the first direction, then another different image is formed, as shown in FIG. 2c. Again, (based on assumed knowledge that the hole 17 is generally cylindrical) one half of the bright silhouette can be attributed to the front 34 of the hole 17, and the other half to the back 32 of the hole 17. This allows additional measurement points 38 to be added to the set of measurement points for the front edge 34 of the hole 17, as well as allowing additional measurement points 36 to be added to the set of measurement points for the back edge 32 of the hole 17.

In this case, the location of the front 34 and back 32 (or top and bottom) edges of the hole is known. For example, this could be known by directly measuring the planar faces of the object 16, e.g. by touching it with a contact probe.

Image analysis can be used to identify a set of measurement points 36 around the edge of the bright silhouette on the image. For example, known edge detection algorithms can be used such as search methods (e.g. Canny algorithm), zero-crossing methods (e.g. Laplacian of Gaussian). A particular example procedure can involve the following steps: i) apply a Gaussian smoothing filter to the whole image; ii) from the knowledge of camera position and the centroid of the hole shape in the image, estimate the image position of the edge centre for both the proximal and distal edges; iii) for both edges estimate the angular range from the centre for which that edge can be seen in silhouette; iv) for both edges interpolate the smoothed image to obtain image intensity data along a number ‘spoke’ lines within the angular range radiating from the edge centre; v) for each spoke calculate the derivative of the intensity data and search for a minimum (using interpolation to give sub-pixel accuracy); and vi) using the camera calibration, and from the known position of the surface skin, calculate a 3D position of the image edge point. This technique can be performed on just one image, and repeated for other images to obtain increased point density and/or for coverage purposes (e.g. because in different images different parts/sides of the hole will/will not be visible).

FIGS. 3a to 3c respectively schematically illustrate the optical situation for the silhouette images in FIGS. 2a to 2c. The rays illustrate the boundary of light reaching the camera probe's image sensor 40. As can be seen in FIG. 3a, when the camera probe's optical axis is at least approximately aligned with the hole's longitudinal axis, the silhouette falling on the image sensor 40 is created by the back edge 32 of the hole 17. However, as illustrated by FIGS. 3b and 3c, when the camera probe 20 is substantially off-axis, then part of the silhouette is created by the front edge 32 of the hole 17 and part of the silhouette is created by the back edge 34 of the hole 17. For the sake of simplicity and to aid understanding of the invention, the camera probe 20 is illustrated in FIGS. 3a to 3c using a pin-hole camera model, but as will be understood, the camera probe 20 can comprise one or more lenses in order to form an image on the image sensor 40 and the same optical illustration applies.

The technique of the present invention can also be used to inspect more complex holes and/or holes of unknown form. In the case in which at least one of the holes 21 in the set 19 is not circular, and/or which varies in size between the front 34 and the back 32, any measurement point on any given silhouette image cannot be easily attributed to a particular point of the hole 17 in 3D space. FIG. 4a shows the silhouette of an irregular hole 21 created when viewing the irregular hole with the camera positioned approximately on the axis of the hole. As shown in FIG. 4b, points on the edge of the silhouette can be transformed to 3D vectors, but the 3D positions at which these vectors graze the wall of the hole (i.e. its “inner surface” or the “hole's boundary”) cannot be determined from just one image. (For the sake of simplicity, the camera probe's image sensor 40 is not shown in

FIG. 4a or subsequent Figures).

If the camera is moved to a number of different positions, then a series of different silhouettes are captured, as shown in FIG. 5a. As illustrated in FIG. 5b, the silhouette images can be analysed to produce a bundle of 3D vectors associated with the different camera viewpoints, and all of these vectors are known to pass through the hole, grazing the wall of the hole at some point.

The bundle of vectors 50 can be processed further in order to infer the shape of the hole 21. As illustrated in FIG. 5c, one method is to create a notional measurement surface 52, (in this case a virtual measurement plane 52) at a given/known position and orientation within the CMM's 10 measurement volume (in particular at a position and orientation that is known will intersect the hole 21). The points 58 at which the vectors cross this plane 52 can then be calculated. A typical distribution 54 of such points on the measurement plane is shown in FIG. 5d. The outer-most points in the distribution (shown joined by a line 56) approximate the shape of the wall of the hole in the virtual measurement plane, and all the other points can be discarded. Known processes (e.g. a “convex hull” algorithm or a “non-convex hull” algorithm (also known as a “concave hull” algorithm)) can be used to infer the outermost points in the distribution. In the embodiment described, the notional measurement surface 52 is planar, but as will be understood this need not necessarily be the case and for example the notional measurement surface could be curved, e.g. conical, spherical, cylindrical or have any regular/irregular form.

As illustrated in FIG. 6a, the overall 3D profile the hole 21 can be inferred by creating a number of notional measurement surfaces 52a to 52e (e.g. virtual measurement planes 52a to 52e) between the front 34 and back 32 faces of the hole 21 (the front 34 and back 32 faces of the object 16 can be known from a direct measurement of them (as described above)), and calculating a set of points which approximate the hole 21 wall's profile in each plane (as described above in connection with FIGS. 5c and 5d). An inferred form of the hole 21 along its length can then be constructed from the total set of points. FIG. 6b illustrates the form of the hole 21 inferred from the bundle of vectors 50 as the bold line 60, superimposed on the actual form of the object 16. As will be understood, the greater number of camera positions, the greater the number of vectors and hence the greater the accuracy of the inferred form of the hole.

FIG. 7a shows an example of a hole 25 with a longitudinal axis which is not perpendicular to the front 34 and back 32 faces of the object 16, with a typical bundle of vectors 50 passing through the hole from four different camera viewpoints. When calculating the profile of the hole 25, measurement planes 52a to 52e may be constructed in any required orientation. FIGS. 7b and 7c show two possible choices. FIG. 7b shows planes 52a to 52b parallel to the front 34 and back 32 faces of the part, and FIG. 7c shows the planes 52a to 52e perpendicular to the longitudinal axis of the hole 25. Depending on the application and the form of measurement data required, each method may have its advantages. For example, by taking planes perpendicular to the axis of the hole 25, it may be easier to calculate the cross-sectional area of the hole 25.

As will be understood, other techniques can be used to process the silhouettes to infer hole boundary information. For example, with reference to FIGS. 8a to 8c there is illustrated another embodiment according to the invention. Here, bounding surfaces 15 are generated, e.g. by direct measurement of the top and/or bottom surfaces of the object 16 in which the hole 17 exists. In a first step illustrated by FIG. 8a, for a first view point/camera perspective centre, a “valid” or “viable” volume 13 through the hole 17 is established. This could (for example) be a set of two-dimensional polygons (e.g. one of which is shown in FIG. 8a) or a three-dimensional frustoconical volume. In a second step illustrated by FIG. 8b, the view point/perspective centre of the camera is moved to a new position generating a new silhouette. The viable volume for that silhouette and view point is generated and used to extend the previously determined valid/viable volume 13, e.g. by a Boolean OR operation. The above process of moving to a new view point/perspective centre, obtaining a new image of the silhouette of the hole 17 and extending the viable volume 13 (as illustrated in FIG. 8c) can be repeated as desired e.g. until there is no silhouette visible and/or enough information about the interior of the hole is known. This technique can be particularly appropriate for determining if any excess material is present within the hole 17.

The above described embodiments illustrate the invention being used to inspect a single hole. The invention can also be used to inspect multiple holes simultaneously. For instance, FIG. 9a shows three images of the array 19 of holes obtained from different viewpoints. As will be understood, any of the techniques described above in connection with FIGS. 1 to 8 can be used to infer the boundary of each of the holes in the array 19. For example, FIG. 9b schematically illustrates the bundle of vectors that have been created from these images. Viable volumes could be fitted to the bundle of vectors for each of the holes (e.g. as in the embodiment of FIGS. 8a to 8c). Optionally, notional measurement surfaces, e.g. planes, that intersect these vector bundles could be used to infer the cross-sectional shape of each hole at the notional measurement surface (e.g. as in the embodiment of FIGS. 4 to 7). Additionally or alternatively, the embodiment of FIG. 2 can also be used which requires more knowledge about the location and assumed shape of the holes in order to use image processing techniques to identify which points of the silhouette images relate to the front and back of the holes. FIG. 9 illustrates the invention being used to inspect a one-dimensional array of holes, but as will understood, the invention can be used to inspect a multi (e.g. two) dimensional array of holes in a object.

In the above described embodiments the camera probe is moved in order to obtain images from different view points. However, the object 19 could be moved instead of or additionally to the camera probe movement. Furthermore, as will be understood, relative movement can be avoided, e.g. by providing multiple camera probes having different view points, and/or (for example) a camera probe having an internally moveable centre of perspective and/or with multiple centres of perspective.

1. A method of inspecting a hole in an object with at least one camera probe mounted on a coordinate positioning machine, comprising:
for a plurality of different viewpoints obtaining at least one image of a silhouette of the hole from a first end of the hole, so as to obtain a set of silhouette images of the hole, the hole being backlit so as to form said silhouette, and
using said set of silhouette images of the hole to infer at least part of the boundary of the hole at a given height.

2. A method as claimed in claim 1, comprising for a plurality of different viewpoints obtaining at least one image of the entire silhouette of the hole from a first end of the hole.

3. A method as claimed in claim 2, comprising for a plurality of different viewpoints obtaining at least one image of the silhouette of a plurality of holes in the object from a first end of the holes.

4. A method as claimed in claim 1, comprising for at least one image using an edge detection process to identify at least one point on an edge of the silhouette in said image.

5. A method as claimed in claim 4, comprising inferring which part of the silhouette in an image relates to a part of the hole at a first height and which part of the silhouette relates to a part of the hole at a second height.

6. A method as claimed claim 1, in which said at least part of the boundary of the hole is proximal or at the end of the hole distal the first end.

7. A method as claimed in claim 1, comprising using said set of silhouette images of the hole to infer at least a part of the boundary of the hole at at least two different heights within the hole.

8. A method as claimed in claim 1, comprising measuring the location of the first end of the hole.

9. A method as claimed in claim 1, in which said at least part of the boundary of the hole is located part way down said hole.

10. A method as claimed in claim 1, comprising determining the position of the boundary of the hole at a plurality of different points on a notional measurement surface that intersects the hole.

11. A method as claimed in claim 10, comprising measuring the location of said notional measurement surface using a different probe.

12. A method as claimed in claim 1, in which inferring comprises determining the vector of at least one light ray that passed through the hole so as to create the silhouette.

13. A method as claimed in claim 1, comprising generating from said set of images at least one notional geometrical construct representing the hole, and using said at least one notional geometrical construct to infer at least part of the boundary of said hole.

14. A method as claimed in claim 13, in which said notional geometrical construct comprises at least one of: a) a bundle of vectors representing light rays known to have passed through said hole; and b) at least one geometrical shape representing at least a part of the hole.

15. A method of inspecting a plurality of holes with a camera probe mounted on a coordinate positioning machine, comprising:
for a plurality of different viewpoints obtaining at least one image of the silhouette of the plurality of holes from a first end of the holes, the holes being backlit so as to form said silhouette,
processing the silhouette images to determine metrological information concerning the plurality of holes.

16. A computer implemented method comprising receiving a silhouette image of a backlit hole in an object obtained from a known viewpoint, and using said at least one silhouette image of the hole to infer at least part of the boundary of the hole at a given height.

17. Computer program code comprising instructions which, when executed by a processor device of the apparatus according to claim 1.

18. A computer readable medium, bearing computer program code as claimed in claim 17.

19. An apparatus comprising:
at least one camera probe mounted on a coordinate positioning apparatus for obtaining images of an object comprising at least one hole to be inspected;
a light source positioned on a first side of the object so as to backlight the object;
a controller configured to control the camera probe such that for at least one view point, at least one image of a silhouette of a hole is obtained from a second side of the object; and
a processor configured to use said at least one silhouette image to infer at least part of the boundary of the hole at a given height.
